(19) United States
(12) Patent Application Publication
(10) Pub. No.: US 2022/0343922 A1
(43) Pub. Date: Oct. 27, 2022

(54) SELECTIVELY AUTHENTICATING A USER USING VOICE RECOGNITION AND RANDOM REPRESENTATIONS

(71) Applicant: Microsoft Technology Licensing, LLC, Redmond, WA (US)

(72) Inventors: Daniel Edward Lee WOOD, Seattle, WA (US); Caleb Geoffrey BAKER, Seattle, WA (US); Amit DHARIWAL, Redmond, WA (US); Akshay NAIK, Mumbai (IN); Pedro Miguel Neno LEITE, Aveiro (PT); Sabina Lauren SMITH, Malvern, PA (US); Juyoung SONG, Newton, MA (US); Kushal JHUNJHUNWALLA, Seattle, WA (US)

(21) Appl. No.: 17/240,672

(22) Filed: Apr. 26, 2021

(51) Int. Cl. G10L 17/24; G06F 21/32

(52) U.S. Cl. CPC G10L 17/24; G06F 21/32

(57) ABSTRACT

Techniques are described herein that are capable of selectively authenticating a user using voice recognition and random representations. A credential that is received from an entity is compared to a reference credential associated with a user. The random representations are caused to be displayed to the entity based at least in part on the credential corresponding to the reference credential. Each random representation has a random entropy. A representation of speech of the entity is analyzed to determine whether a voice characterized by the speech corresponds to a voice profile that characterizes a voice of the user and to determine whether the speech includes a verbal identification of each random representation. The user is selectively authenticated based at least in part on whether the voice corresponds to the voice profile and further based at least in part on whether the speech includes the verbal identification of each random representation.

### BACKGROUND

Authentication of a user establishes truth of an assertion that an entity is the user. Multifactor authentication (MFA) is authentication in which the assertion includes two or more factors. Each factor may include something the user knows (e.g., only the user knows), something the user has (e.g., only the user has), or something the user is (e.g., only the user is). Examples of something the user knows include but are not limited to a username, a password, a personal identification number (PIN), and a transaction authentication number (TAN). Examples of something the user has include but are not limited to a personal digital assistant, a mobile phone, a hardware token, and a FIDO token. Examples of something the user is include but are not limited to a fingerprint, an eye iris, a face identifier (ID), and a voice.

A variety of MFA techniques has been proposed for authenticating a user. However, each such technique has its limitations. For example, in MFA techniques that are based on something the user has, an object that is expected to be in the user's possession for purposes of authentication may be lost, forgotten, or stolen. Moreover, a cost of the object may be relatively high, and distribution of the object may be relatively complex. In another example, scanners that are used to scan biometric features (e.g., fingerprint, facial ID) in MFA techniques that are based on something the user is often are relatively expensive, and such techniques may be impeded by clothing (e.g., gloves, masks) worn by the user.

Some MFA techniques utilize voice recognition by making a telephone call to the user and requesting that the user recite a predetermined phrase. However, telephone calls are relatively expensive and are relatively insecure. Moreover, utilizing a predetermined phrase enables a malicious entity to play a recording of the user's voice saying the predetermined phrase for purposes of authentication.

### SUMMARY

Various approaches are described herein for, among other things, selectively authenticating a user using voice recognition and random representations. Examples of a random representation include but are not limited to a random alphanumeric character, a random alphanumeric combination, a random symbol, and a random picture. An alphanumeric character is a single-digit number (e.g., an Arabic digit) or a letter (e.g., a Latin letter). A letter is a unit of an alphabet. An alphanumeric combination includes multiple alphanumeric characters. Examples of an alphanumeric combination include but are not limited to a word, an alphanumeric character string, a snippet, and a multi-digit number. A word is an alphanumeric combination that has a defined meaning in a language. An alphanumeric character string may include any number of number(s) and/or letter(s), so long as the alphanumeric character string includes at least two alphanumeric characters. A snippet includes multiple letters and no numbers. A multi-digit number includes multiple numbers and no letters. A symbol is a non-alphanumeric character. A non-alphanumeric character is a character that is neither a letter nor a number. Examples of a picture include but are not limited to a photograph and a drawing. Authentication of the user may be based on (e.g., based at least in part on) any combination of the above-recited example random representations. For instance, the random representations may include any number (0, 1, 2, 3, 4, 5, . . . , N) of random alphanumeric characters, any number of random alphanumeric combinations, any number of random symbols, and any number of random pictures.

In an example approach of selectively authenticating a user using voice recognition and random representations, a credential that is received from an entity is compared to a reference credential that is associated with a user to determine whether the credential corresponds to the reference credential. The random representations are caused to be displayed to the entity based at least in part on the credential corresponding to the reference credential. Each random representation has a random entropy. A representation of speech of the entity is analyzed to determine whether a voice that is characterized by the speech corresponds to a voice profile that characterizes a voice of the user and to determine whether the speech includes a verbal identification of each random representation. The user is selectively authenticated based at least in part on whether the voice that is characterized by the speech corresponds to the voice profile that characterizes the voice of the user and further based at least in part on whether the speech includes the verbal identification of each random representation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example randomization-based authentication system in accordance with an embodiment.

FIG. 2 depicts an example web page that enables an information technology (IT) administrator to register user(s) of an enterprise with a voice recognition service for purposes of authentication in accordance with an embodiment.

FIG. 3 depicts an example user interface that is configured to enable a user to select from multiple authentication policies, including a Voice recognition policy, for purposes of authentication in accordance with an embodiment.

FIG. 4 depicts an example user interface that is presented to the user in response to the user selecting the Voice recognition policy from the authentication policies shown in FIG. 3 in accordance with an embodiment.

FIGS. 5-7 depict flowcharts of example methods for selectively authenticating a user using voice recognition and random representations in accordance with embodiments.

FIG. 8 is a block diagram of an example computing system in accordance with an embodiment.

FIG. 9 is a system diagram of an exemplary mobile device in accordance with an embodiment.

FIG. 10 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

### II. Example Embodiments

Example embodiments described herein are capable of selectively authenticating a user using voice recognition and random representations. Examples of a random representation include but are not limited to a random alphanumeric character, a random alphanumeric combination, a random symbol, and a random picture. An alphanumeric character is a single-digit number (e.g., an Arabic digit) or a letter (e.g., a Latin letter). A letter is a unit of an alphabet. An alphanumeric combination includes multiple alphanumeric characters. Examples of an alphanumeric combination include but are not limited to a word, an alphanumeric character string, a snippet, and a multi-digit number. A word is an alphanumeric combination that has a defined meaning in a language. An alphanumeric character string may include any number of number(s) and/or letter(s), so long as the alphanumeric character string includes at least two alphanumeric characters. A snippet includes multiple letters and no numbers. A multi-digit number includes multiple numbers and no letters. A symbol is a non-alphanumeric character. A non-alphanumeric character is a character that is neither a letter nor a number. Examples of a picture include but are not limited to a photograph and a drawing. Authentication of the user may be based on (e.g., based at least in part on) any combination of the above-recited example random representations. For instance, the random representations may include any number (0, 1, 2, 3, 4, 5, . . . , N) of random alphanumeric characters, any number of random alphanumeric combinations, any number of random symbols, and any number of random pictures.

When the random representations are displayed to an entity, the voice recognition may be employed to determine whether the entity's speech identifies the random representations and corresponds to a profile of the user's voice. For instance, the profile of the user's voice may be stored in a secure enclave (e.g., trusted platform module) on a computing system that is associated with the user, in a secure enclave of a browser that executes on the computing system, or in a secure enclave of a server that is located remotely from the computing system. Storing the profile of the user's voice on the computing system associated with the user or a browser that executes thereon may alleviate concerns of consumers regarding storage of the voice profile on a server. The voice recognition may be performed by the browser, another application executing on the computing system, or the server.

Example techniques described herein have a variety of benefits as compared to conventional techniques for authenticating a user. For instance, the example techniques may be capable of increasing security of a computing system and/or an account of the user. For example, authentication of the user may be performed over an encrypted hypertext transfer protocol secure (HTTPS) connection, rather than using short message service (SMS) or telephone communications, which are less secure than the HTTPS connection. Moreover, using random representations rather than predetermined phrases introduces entropy and may inhibit (e.g., prevent) a malicious entity from being able to play a recording of the user's voice to authenticate with an account or computing system of the user. By storing the profile of the user's voice on a computing system associated with the user or a browser that executes thereon, concerns of consumers regarding storage of the voice profile on a server may be alleviated. Storing the voice profile of the user on the computing system or the browser may further increase the security of the security system and/or an account of the user. Accordingly, the example techniques may reduce a likelihood that a malicious entity will be able to gain access to an account or computing system of the user.

The user need not necessarily purchase or possess a particular object for purposes of authentication in accordance with the example techniques. By not requiring the user to purchase and maintain possession of such an object, the example techniques may improve (e.g., increase) a user experience of the user, increase efficiency of the user, reduce a cost associated with authentication, and/or simplify the authentication process. The example techniques may reduce the cost associated with authentication in other ways, for example, by not requiring the use of SMS communications, telephone communications, and/or biometric scanners. The example techniques may be more efficient, reliable, and/or effective than conventional authentication techniques, for example, by not being negatively affected by clothing (e.g., masks or gloves) worn by the user. The example techniques may be capable of more accurately and/or precisely determining whether an assertion by an entity that the entity is the user is true, as compared to conventional authentication techniques.

The example techniques may be incorporated into an enterprise identity access management platform (e.g., Azure® Active Directory® developed and distributed by Microsoft Corporation) or a consumer identity access management platform (e.g., Microsoft® Account™ developed and distributed by Microsoft Corporation). The example techniques may be integrated into an artificial intelligence (AI) service, for example, to add AI capabilities to a software application for purposes of authenticating a user. One example of an AI service is Azure® Cognitive Services™ developed and distributed by Microsoft Corporation.

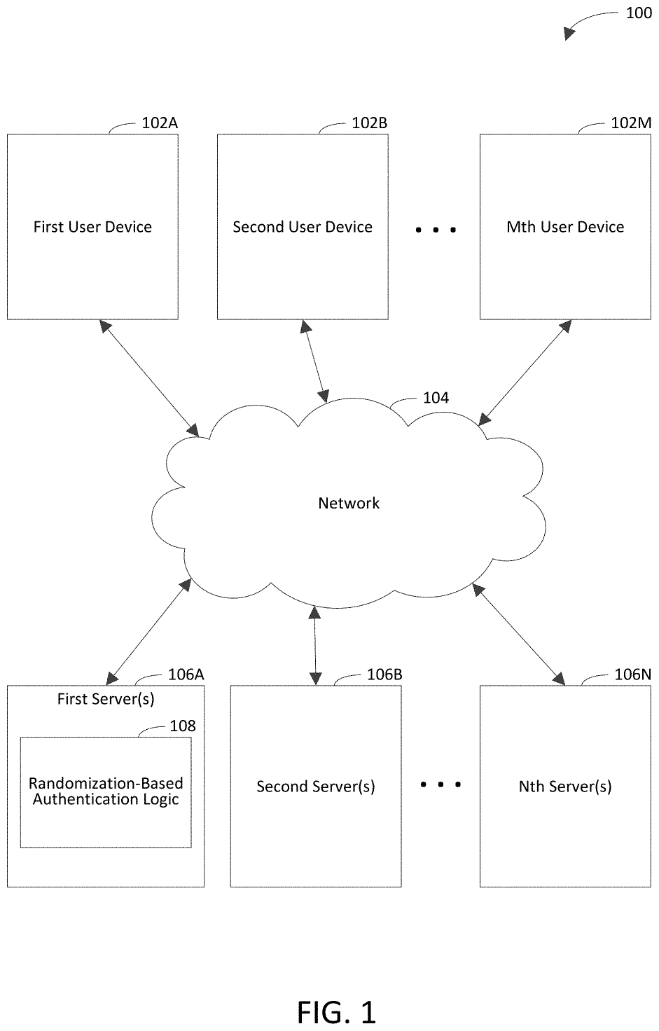

FIG. 1 is a block diagram of an example randomization-based authentication system 100 in accordance with an embodiment. Generally speaking, the randomization-based authentication system 100 operates to provide information to users in response to requests (e.g., hypertext transfer protocol (HTTP) requests) that are received from the users. The information may include documents (Web pages, images, audio files, video files, etc.), output of executables, and/or any other suitable type of information. In accordance with example embodiments described herein, the randomization-based authentication system 100 selectively authenticates a user of the randomization-based authentication system 100 using voice recognition and random representations. Detail regarding techniques for selectively authenticating a user using voice recognition and random representations is provided in the following discussion.

As shown in FIG. 1, the randomization-based authentication system 100 includes a plurality of user devices 102A-102M, a network 104, and a plurality of servers 106A-106N. Communication among the user devices 102A-102M and the servers 106A-106N is carried out over the network 104 using well-known network communication protocols. The network 104 may be a wide-area network (e.g., the Internet), a local area network (LAN), another type of network, or a combination thereof.

The user devices 102A-102M are processing systems that are capable of communicating with servers 106A-106N. An example of a processing system is a system that includes at least one processor that is capable of manipulating data in accordance with a set of instructions. For instance, a processing system may be a computer, a personal digital assistant, etc. The user devices 102A-102M are configured to provide requests to the servers 106A-106N for requesting information stored on (or otherwise accessible via) the servers 106A-106N. For instance, a user may initiate a request for executing a computer program (e.g., an application) using a client (e.g., a Web browser, Web crawler, or other type of client) deployed on a user device 102 that is owned by or otherwise accessible to the user. In accordance with some example embodiments, the user devices 102A-102M are capable of accessing domains (e.g., Web sites) hosted by the servers 104A-104N, so that the user devices 102A-102M may access information that is available via the domains. Such domain may include Web pages, which may be provided as hypertext markup language (HTML) documents and objects (e.g., files) that are linked therein, for example.

Each of the user devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the user devices 102A-102M may communicate with any one or more of the servers 106A-106N.

The servers 106A-106N are processing systems that are capable of communicating with the user devices 102A-102M. The servers 106A-106N are configured to execute computer programs that provide information to users in response to receiving requests from the users. For example, the information may include documents (Web pages, images, audio files, video files, etc.), output of executables, or any other suitable type of information. Any one or more of the computer programs may be a cloud computing service. A cloud computing service is a service that executes at least in part in the cloud. The cloud may be a remote cloud, an on-premises cloud, or a hybrid cloud. It will be recognized that an on-premises cloud may use remote cloud services. Examples of a cloud computing service include but are not limited to Azure® developed and distributed by Microsoft Corporation, Google Cloud® developed and distributed by Google Inc., Oracle Cloud® developed and distributed by Oracle Corporation, Amazon Web Services® developed and distributed by Amazon.com, Inc., Salesforce® developed and distributed by Salesforce.com, Inc., and Rackspace® developed and distributed by Rackspace US, Inc. In accordance with some example embodiments, the servers 106A-106N are configured to host respective Web sites, so that the Web sites are accessible to users of the randomization-based authentication system 100.

The first server(s) 106A are shown to include randomization-based authentication logic 108 for illustrative purposes. The randomization-based authentication logic 108 is configured to selectively authenticate a user using voice recognition and random representations. In an example implementation, the randomization-based authentication logic 108 compares a credential that is received from an entity to a reference credential that is associated with the user to determine whether the credential corresponds to the reference credential. The randomization-based authentication logic 108 causes the random representations to be displayed to the entity based at least in part on the credential corresponding to the reference credential. Each random representation has a random entropy. The randomization-based authentication logic 108 analyzes a representation of speech of the entity to determine whether a voice that is characterized by the speech corresponds to a voice profile that characterizes a voice of the user and to determine whether the speech includes a verbal identification of each random representation. The randomization-based authentication logic 108 selectively authenticates the user based at least in part on whether the voice that is characterized by the speech corresponds to the voice profile that characterizes the voice of the user and further based at least in part on whether the speech includes the verbal identification of each random representation.

The randomization-based authentication logic 108 may use machine learning to perform at least some of its operations. For instance, the randomization-based authentication logic 108 may use the machine learning to develop and refine the voice profile that characterizes the voice of the user. The randomization-based authentication logic 108 may use the machine learning to analyze the representation of the speech of the entity to determine whether the voice that is characterized by the speech corresponds to the voice profile and/or to determine whether the speech includes a verbal identification of each random representation.

The randomization-based authentication logic 108 may use a neural network to perform the machine learning to predict values of respective attributes of the user's voice. The randomization-based authentication logic 108 may use the voice profile that characterizes the voice of the user to predict the values of the respective attributes of the user's voice and/or may incorporate the predicted values into the voice profile. Examples of a neural network include but are not limited to a feed forward neural network and a long short-term memory (LSTM) neural network. A feed forward neural network is an artificial neural network for which connections between units in the neural network do not form a cycle. The feed forward neural network allows data to flow forward (e.g., from the input nodes toward to the output nodes), but the feed forward neural network does not allow data to flow backward (e.g., from the output nodes toward to the input nodes). In an example embodiment, the randomization-based authentication logic 108 employs a feed forward neural network to train a machine learning model that is used to determine ML-based confidences. Such ML-based confidences may be used to determine likelihoods that events will occur.

An LSTM neural network is a recurrent neural network that has memory and allows data to flow forward and backward in the neural network. The LSTM neural network is capable of remembering values for short time periods or long time periods. Accordingly, the LSTM neural network may keep stored values from being iteratively diluted over time. In one example, the LSTM neural network may be capable of storing information, such as historical values of respective attributes of the user's voice over time. For instance, the LSTM neural network may generate a speech model and/or a voice model by utilizing such information. In another example, the LSTM neural network may be capable of remembering relationships between features, such as spectral distributions, cadences, inflections, accents, dialects, probabilities that respective voices correspond to the voice profile, verbal identifications of respective random representations, and ML-based confidences that are derived therefrom.

The randomization-based authentication logic 108 may include training logic and inference logic. The training logic is configured to train a machine learning algorithm that the inference logic uses to determine (e.g., infer) the ML-based confidences. For instance, the training logic may provide sample spectral distributions, sample cadences, sample inflections, sample accents, sample dialects, sample probabilities that respective voices correspond to the voice profile, sample verbal identifications of respective random representations, and sample confidences as inputs to the algorithm to train the algorithm. The sample data may be labeled. The machine learning algorithm may be configured to derive relationships between the features (e.g., spectral distributions, cadences, inflections, accents, dialects, probabilities that respective voices correspond to the voice profile, and verbal identifications of respective random representations) and the resulting ML-based confidences. The inference logic is configured to utilize the machine learning algorithm, which is trained by the training logic, to determine the ML-based confidence when the features are provided as inputs to the algorithm.

The randomization-based authentication logic 108 may be implemented in various ways to selectively authenticate a user using voice recognition and random representations, including being implemented in hardware, software, firmware, or any combination thereof. For example, the randomization-based authentication logic 108 may be implemented as computer program code configured to be executed in one or more processors. In another example, at least a portion of the randomization-based authentication logic 108 may be implemented as hardware logic/electrical circuitry. For instance, at least a portion of the randomization-based authentication logic 108 may be implemented in a field-programmable gate array (FPGA), an application-specific integrated circuit (ASIC), an application-specific standard product (ASSP), a system-on-a-chip system (SoC), a complex programmable logic device (CPLD), etc. Each SoC may include an integrated circuit chip that includes one or more of a processor (a microcontroller, microprocessor, digital signal processor (DSP), etc.), memory, one or more communication interfaces, and/or further circuits and/or embedded firmware to perform its functions.

The randomization-based authentication logic 108 may be partially or entirely incorporated in a cloud computing service, though the example embodiments are not limited in this respect.

The randomization-based authentication logic 108 is shown to be incorporated in the first server(s) 106A for illustrative purposes and is not intended to be limiting. It will be recognized that the randomization-based authentication logic 108 (or any portion(s) thereof) may be incorporated in any one or more of the user devices 102A-102M. For example, client-side aspects of the randomization-based authentication logic 108 may be incorporated in one or more of the user devices 102A-102M, and server-side aspects of randomization-based authentication logic 108 may be incorporated in the first server(s) 106A. In another example, the randomization-based authentication logic 108 may be distributed among the user devices 102A-102M. In yet another example, the randomization-based authentication logic 108 may be incorporated in a single one of the user devices 102A-102M. In another example, the randomization-based authentication logic 108 may be distributed among the server(s) 106A-106N. In still another example, the randomization-based authentication logic 108 may be incorporated in a single one of the servers 106A-106N.

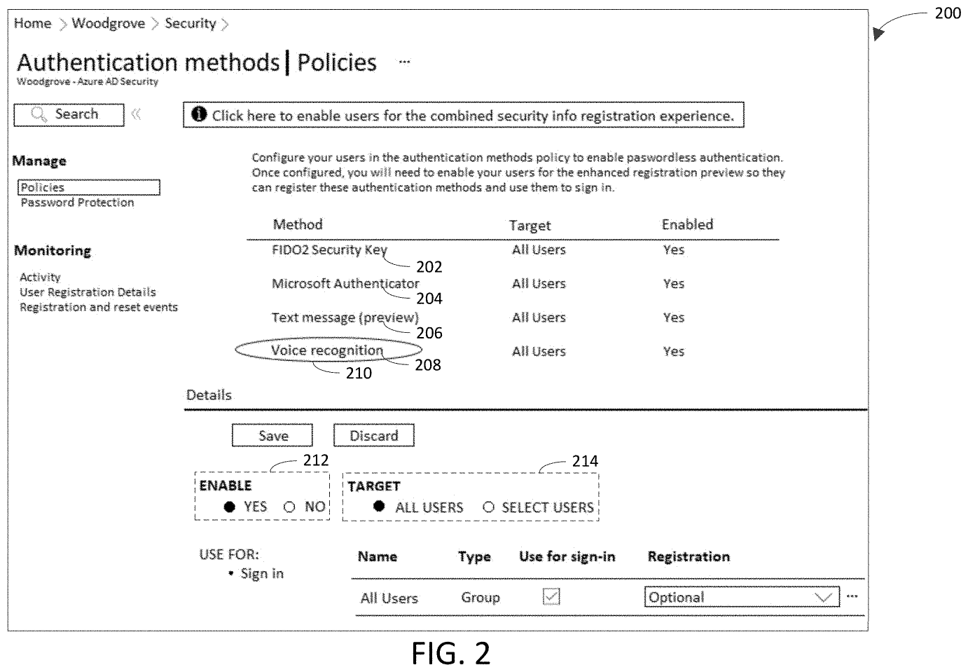

FIG. 2 depicts an example web page 200 that enables an information technology (IT) administrator who manages authentication policies associated with users of an enterprise to register any one or more of the users with a voice recognition service for purposes of authentication in accordance with an embodiment. As shown in FIG. 2, the IT administrator has enabled a FIDO2 security key policy, a Microsoft Authenticator policy, a Text message policy, and a Voice recognition policy for all users of the enterprise. The FIDO2 security key policy, the Microsoft Authenticator policy, the Text message policy, and the Voice recognition policy correspond to (e.g., are represented by) respective interface elements 202, 204, 206, and 208. The interface elements 202, 204, 206, and 208 are individually selectable by the IT administrator. For instance, interface element 208, which corresponds to the Voice recognition policy, is shown to be selected, as indicated by oval 210. Accordingly, the Voice recognition policy is said to be selected.

An enabling interface element 212 may be toggled by the IT administrator to control whether a selected policy (the Voice recognition policy 208 in this example) is enabled. The enabling interface element 212 is shown to be in an enabling position “Yes,” which causes the selected policy to be enabled. The enabling interface element 212 may be toggled to a non-enabling position “No” to disable the selected policy. The enabling interface element 212 may be implemented as a radio button as shown in FIG. 2, though the scope of the example embodiments is not limited in this respect.

A targeting interface element 214 may be toggled by the IT administrator to control to which users of the enterprise the selected policy is to apply. The targeting interface element 214 is shown to be in a first position “All users,” which causes the selected policy to be applied to all users of the enterprise. The targeting interface element 214 may be toggled to a second position “Select users” to enable the IT administrators to select to which of the users the selected policy is to apply. For instance, by toggling the targeting interface element 214 to the second position, the IT administrator may be presented with a list of the users and an ability to select any one or more of the users from the list for application of the selected policy. The targeting interface element 214 may be implemented as a radio button as shown in FIG. 2, though the scope of the example embodiments is not limited in this respect.

It will be recognized that if a user manages her own authentication policies, she may navigate to a portal having at least some of the features shown in the web page 200, for example, to register (e.g., add), unregister (e.g., delete), or change a configuration of any one or more of the policies that are available to the user. If the user adds voice recognition as a new authentication technique, for example by registering the Voice recognition policy, the user may be presented with a prompt, requesting the user to train the voice recognition algorithm. For instance, the user may train the voice recognition algorithm by reciting a textual passage, which is displayed to the user, for at least a specified duration of time (e.g., 15 seconds, 20 second, or 30 seconds). Once the user has trained the voice recognition algorithm, the user will be capable of using voice recognition as an authentication technique. The user may select an option to allow microphone access in the browser to enable functionality of the voice recognition authentication technique.

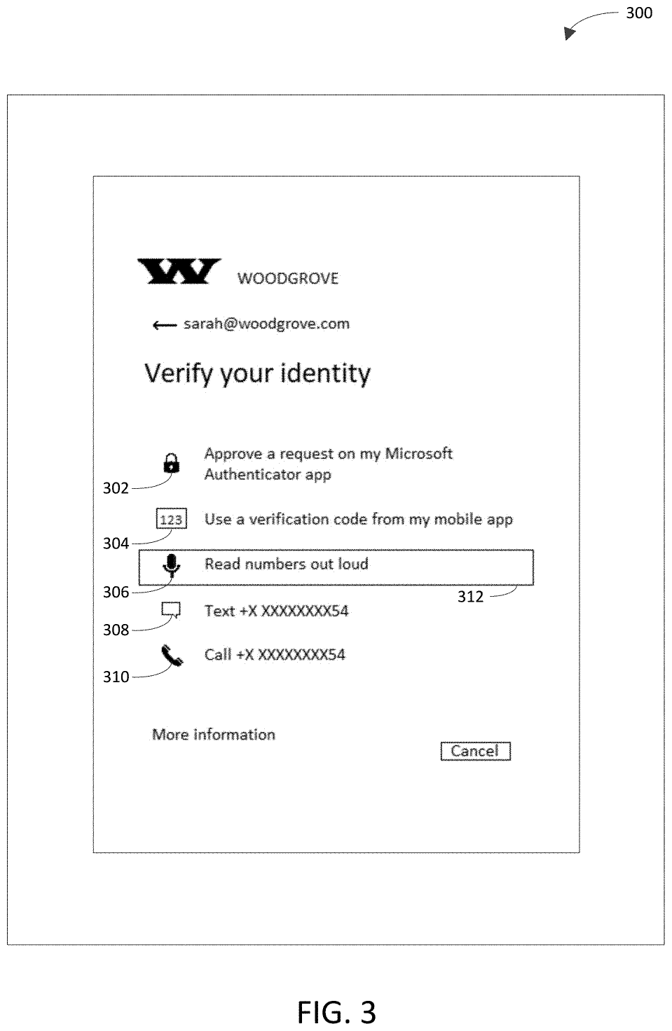

FIG. 3 depicts an example user interface 300 that may be presented to a user to enable the user to select from multiple authentication policies that apply to the user in accordance with an embodiment. The user may select one of the interface elements 302, 304, 306, 308, and 310, which correspond to the respective policies, to authenticate in accordance with the selected policy. For instance, the user may select a first interface element 302 to authenticate using a Microsoft Authenticator policy. The user may select a second interface element 304 to authenticate in accordance with a Verification code policy. The user may select a third interface element 306 to authenticate in accordance with a Voice recognition policy. The user may select a fourth interface element 308 to authenticate in accordance with a Text message policy. The user may select a fifth interface element 310 to authenticate in accordance with a Telephone call policy. As shown in FIG. 3, the third interface element 306, which corresponds to the Voice recognition policy, has been selected by the user, as indicated by rectangle 312. Accordingly, the Voice recognition policy is said to be selected.

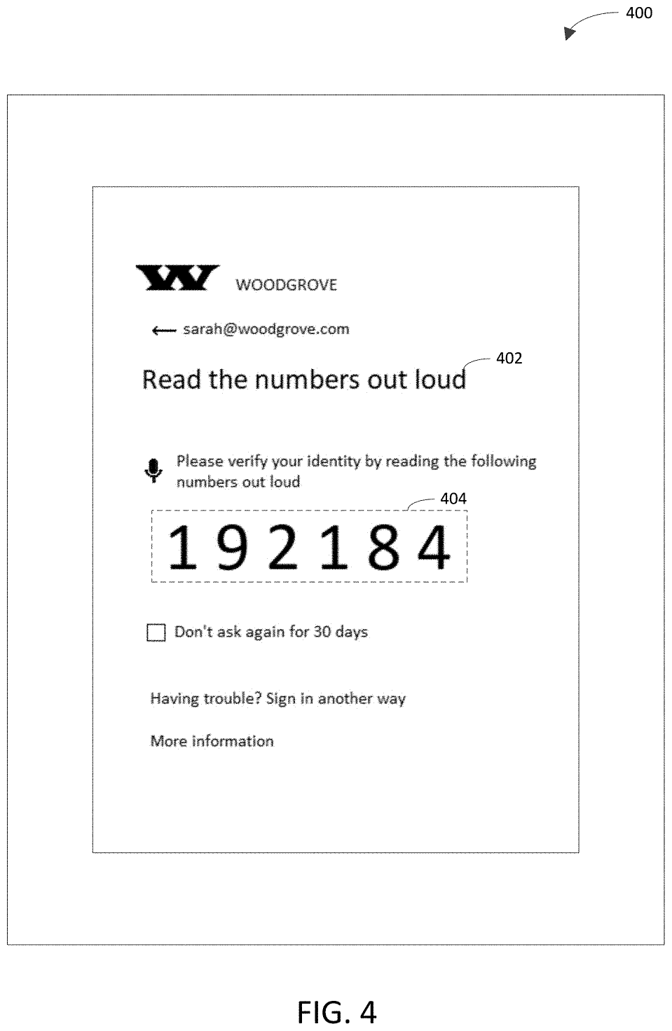

FIG. 4 depicts an example user interface 400 that is presented to the user in response to the user selecting the third interface element 306, corresponding to the Voice recognition policy, in FIG. 3 in accordance with an embodiment. As shown in FIG. 4, the user interface 400 includes an instruction interface element 402 and multiple representations 404. The representations 404 are shown to be numbers for non-limiting, illustrative purposes. For instance, the representations are listed as follows: “1 9 2 1 8 4.” It will be recognized that the representations 404 may be of any suitable type(s) (e.g., numbers, letters, alphanumeric combinations, symbols, pictures, or any combination thereof). The instruction interface element 402 instructs the user to read the numbers aloud. For instance, the randomization-based authentication logic 108 in FIG. 1 may analyze the user's verbal recitation of the numbers to determine whether the user is to be authenticated.

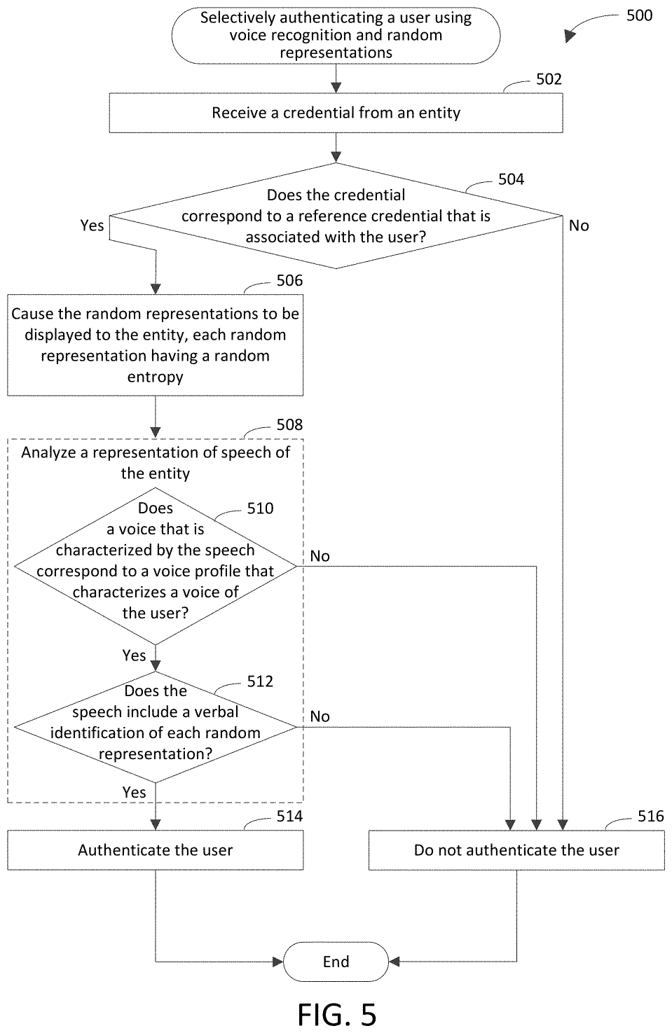

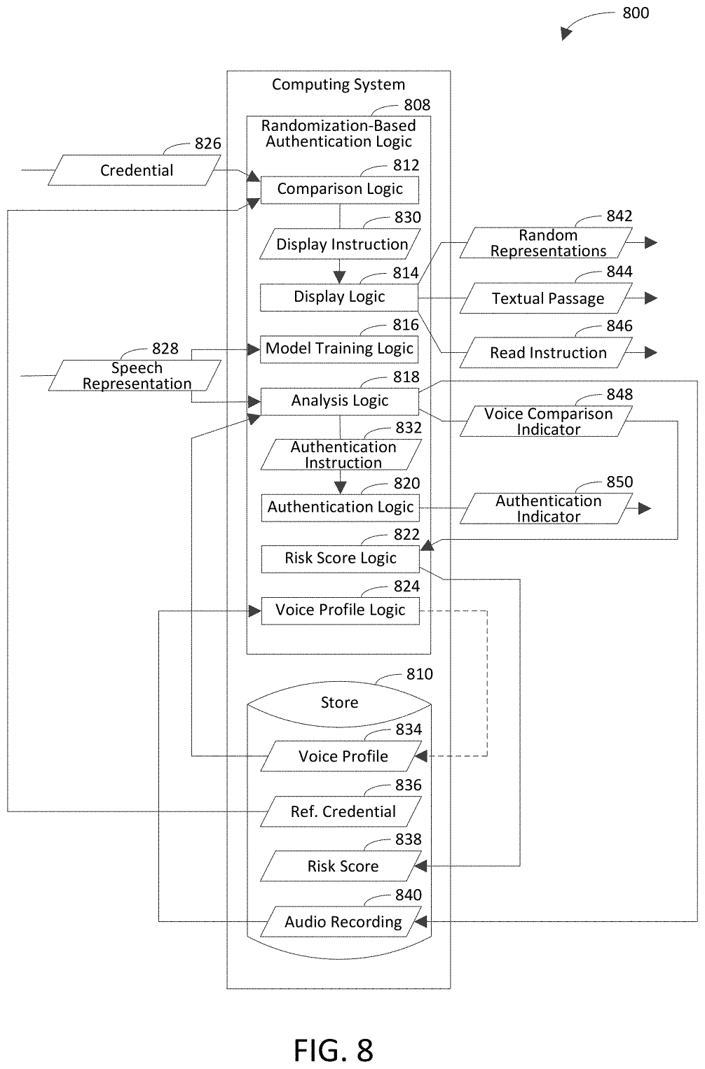

FIGS. 5-7 depict flowcharts 500, 600, and 700 of example methods for selectively authenticating a user using voice recognition and random representations in accordance with embodiments. Flowcharts 500, 600, and 700 may be performed by the first server(s) 106A, shown in FIG. 1, for example. For illustrative purposes, flowcharts 500, 600, and 700 are described with respect to computing system 800 shown in FIG. 8, which is an example implementation of the first server(s) 106A. As shown in FIG. 8, the computing system 800 includes randomization-based authentication logic 808 and a store 810. The randomization-based authentication logic 808 includes comparison logic 812, display logic 814, model training logic 816, analysis logic 818, authentication logic 820, risk score logic 822, and voice profile logic 824. The store 810 may be any suitable type of store. One type of store is a database. For instance, the store 810 may be a relational database, an entity-relationship database, an object database, an object relational database, an extensible markup language (XML) database, etc. The store 810 is shown to store a voice profile 834, a reference credential 836, a risk score 838, and an audio recording 840 for non-limiting illustrative purposes. Further structural and operational embodiments will be apparent to persons skilled in the relevant art(s) based on the discussion regarding flowcharts 500, 600, and 700.

As shown in FIG. 5, the method of flowchart 500 begins at step 502. In step 502, a credential is received from an entity (e.g., a person). Examples of a credential include but are not limited to a username, a password, a personal identification number (PIN), information from a hardware token or a FIDO token, an authenticator push notification from a mobile device, and a transaction authentication number (TAN). In an example implementation, the comparison logic 812 receives a credential 826 from the entity.

At step 504, a determination is made whether the credential corresponds to a reference credential that is associated with the user. For instance, the credential may be compared to the reference credential to make the determination. The credential corresponding to the reference credential may involve the credential and the reference credential being same, the credential and the reference credential being semantically same, or a likelihood that the credential and the reference credential correspond being greater than or equal to a likelihood threshold. If the credential corresponds to the reference credential, flow continues to step 506. Otherwise, flow continues to step 516. In an example implementation, the comparison logic 812 determines whether the credential 826 corresponds to the reference credential 836, which is associated with the user. For instance, the comparison logic 812 may compare the credential 826 to the reference credential 836 to determine whether the credential 826 corresponds to the reference credential 836. The comparison logic 812 may generate a display instruction 830, indicating whether random representations 842 are to be displayed, based on (e.g., based at least in part on) whether the credential 826 corresponds to the reference credential 836.

In one example, the comparison logic 812 is configured to generate the display instruction 830 based on the credential 826 corresponding to the reference credential 836 and is further configured to not generate the display instruction 830 based on the credential 826 not corresponding to the reference credential 836. In accordance with this example, the display instruction 830 instructs the display logic 814 to cause the random representations 842 to be displayed.

In another example, the comparison logic 812 is configured to generate the display instruction 830 to have a first value based on the credential 826 corresponding to the reference credential 836 and is further configured to generate the display instruction 830 to have a second value, which is different from the first value, based on the credential 826 not corresponding to the reference credential 836. In accordance with this example, the display instruction 830 having the first value indicates that the random representations 842 are to be displayed, and the display instruction 830 having the second value indicates that the random representations 842 are not to be displayed.

At step 506, the random representations are caused to be displayed to the entity. For instance, the random representations may be displayed to the entity via a user interface of a computing device that is owned by or otherwise associated with the user (e.g., as a result of the credential corresponding to the reference credential). Each random representation has a random entropy. The random representations may include at least a threshold number (e.g., 3, 4, 5, 6, 7, or 8) of random representations. In an example implementation, the display logic 814 causes the random representations 842 to be displayed. For example, the display logic 814 may display the random representations 842. In another example, the display logic 814 may instruct another computing system (i.e., other than computing system 800) to display the random representations 842. The display logic 814 may be configured to selectively cause the random representations 842 to be displayed depending on whether the display instruction 830 is received or depending on a value of the display instruction 830. For example, the display logic 814 may be configured to cause the random representations 842 to be displayed based on receipt of the display instruction 830. In accordance with this example, the display logic 814 may be configured to not cause the random representations 842 to be displayed based on the display instruction 830 not being received. In another example, the display logic 814 may be configured to cause the random representations 842 to be displayed based on the display instruction 830 having the first value. In accordance with this example, the display logic 814 may be configured to not cause the random representations 842 to be displayed based on the display instruction 830 having the second value. The display logic 814 may further display a read instruction 846 to instruct the entity to verbally identify each of the random representations 842. For instance, the read instruction 846 may instruct the entity to audibly read or verbally describe each of the random representations 842.

In an example embodiment, causing the random representations to be displayed to the entity at step 506 includes causing the random representations to be displayed to the entity via an encrypted hypertext transfer protocol secure (HTTPS) browser communication.

At step 508, a representation of speech of the entity is analyzed. For instance, analyzing the representation of the speech of the entity at step 508 may include analyzing an encrypted hypertext transfer protocol secure (HTTPS) browser communication, which represents the speech of the entity. The representation of the speech may indicate (e.g., include) any of a variety of attributes of the entity's speech or voice, including but not limited to a spectral distribution (e.g., for each of multiple time instances, each of multiple phonemes, or each of the random representations), a cadence, an accent of the entity, a dialect of the entity, etc. In an example implementation, analysis logic 818 analyzes a speech representation 828, which includes the representation of the speech of the entity. For instance, the analysis logic 818 may analyze the speech representation 828 to determine whether the speech of the entity satisfies criteria for establishing that the entity is the user.

Step 508 includes steps 510 and 512. At step 510, a determination is made whether a voice that is characterized by the speech corresponds to a voice profile that characterizes a voice of the user. For instance, attributes of the voice that are indicated by the speech may be compared to attributes of the voice profile to determine whether the voice corresponds to the voice profile. The voice profile may be hashed, for example, to inhibit (e.g., prevent) malicious entities from accessing the voice profile without authorization. The voice profile may be stored on a server (e.g., a secure enclave thereon), a machine that is used by the user (e.g., a trusted platform module (TPM) thereon), or a browser (e.g., a secure enclave thereon) that executes on the machine. If the voice that is characterized by the speech corresponds to the voice profile, flow continues to step 512. Otherwise, flow continues to step 516. In an example implementation, the analysis logic 818 determines whether the voice that is characterized by the speech corresponds to the voice profile 834, which characterizes the voice of the user.

At step 512, a determination is made whether the speech includes a verbal identification of each random representation. If the speech includes the verbal identification of each random representation, flow continues to step 514. Otherwise, flow continues to step 516. In an example implementation, the analysis logic 818 determines whether the speech includes a verbal identification of each of the random representations 842.

The analysis logic 818 may generate an authentication instruction 832 to indicate whether the user is to be authenticated. For instance, the authentication instruction 832 may indicate whether the speech of the entity satisfies the criteria for establishing that the entity is the user. It will be recognized that in this example, the criteria include (1) the voice that is characterized by the speech corresponds to the voice profile 834 (as determined at step 510) and (2) the speech includes the verbal identification of each of the random representations 842 (as determined at step 512). Other potential criteria for establishing that the entity is the user are discussed below.

In one example, the analysis logic 818 is configured to generate the authentication instruction 832 based on the criteria being satisfied and is further configured to not generate the authentication instruction 832 based on any one or more of the criteria not being satisfied. In accordance with this example, the authentication instruction 832 instructs the authentication logic 820 to authenticate the user.

In another example, the analysis logic 818 is configured to generate the authentication instruction 832 to have a first value based on the criteria being satisfied and is further configured to generate the authentication instruction 832 to have a second value, which is different from the first value, based on the criteria not being satisfied. In accordance with this example, the authentication instruction 832 having the first value indicates that the user is to be authenticated, and the authentication instruction 832 having the second value indicates that the user is not to be authenticated.

At step 514, the user is authenticated. In an example, the authentication may be for purposes of signing-in to (e.g., registering with) an application or a service. In another example, the authentication may be for purposes of resetting or recovering a password of the user (a.k.a. account recovery). In an example implementation, the authentication logic 820 authenticates the user. The authentication logic 820 may generate an authentication indicator 850 to indicate that the user is authenticated.

At step 516, the user is not authenticated. In an example implementation, the authentication logic 820 does not authenticate the user.

The authentication logic 820 may be configured to selectively authenticate the user depending on whether the authentication instruction 832 is received or depending on a value of the authentication instruction 832. For example, the authentication logic 820 may be configured to authenticate the user based on receipt of the authentication instruction 832. In accordance with this example, the authentication logic 820 may be configured to not authenticate the user based on the authentication instruction 832 not being received. In another example, the authentication logic 820 may be configured to authenticate the user based on the authentication instruction 832 having the first value. In accordance with this example, the authentication logic 820 may be configured to not authenticate the user based on the authentication instruction 832 having the second value.

In an example embodiment, causing the random representations to be displayed to the entity at step 506 includes causing the random representations to be displayed to the entity such that the random representations are arranged in a designated order. In accordance with this embodiment, determining whether the speech includes a verbal identification of each random representation at step 512 includes determining whether the speech includes the verbal identifications of the random representations in the designated order. Accordingly, authenticating the user at step 514 may be based at least in part on the speech including the verbal identifications of the random representations in the designated order, Not authenticating the user at step 516 may be based at least in part on the speech not including the verbal identifications of the random representations in the designated order.

In another example embodiment, the random representations are random alphanumeric representations. Each random alphanumeric representation includes one or more alphanumeric characters. Accordingly, each alphanumeric representation may be an alphanumeric character or an alphanumeric combination. In accordance with this embodiment, each random alphanumeric representation has a random entropy. In further accordance with this embodiment, causing the random representations to be displayed to the entity at step 506 includes causing the random alphanumeric representations to be displayed to the entity. In further accordance with this embodiment, determining whether the speech includes a verbal identification of each random representation at step 512 includes determining whether the speech includes a reading of each random alphanumeric representation. Accordingly, authenticating the user at step 514 may be based at least in part on the speech including the reading of each random alphanumeric representation. Not authenticating the user at step 516 may be based at least in part on the speech not including the reading of each random alphanumeric representation.

In an aspect of this embodiment, the random alphanumeric representations may be random words. A word is an alphanumeric combination that has a defined meaning in a language. In accordance with this aspect, each random word has a random entropy. In further accordance with this aspect, causing the random alphanumeric representations to be displayed to the entity includes causing the random words to be displayed to the entity. In further accordance with this aspect, determining whether the speech includes the reading of each random alphanumeric representation includes determining whether the speech includes a reading of each random word. Accordingly, authenticating the user at step 514 may be based at least in part on the speech including the reading of each random word. Not authenticating the user at step 516 may be based at least in part on the speech not including the reading of each random word.

In another aspect of this embodiment, the random alphanumeric representations may be random digits of a random number, and the random digits may be in a designated order. In accordance with this aspect, each random digit of the random number has a random entropy. In further accordance with this aspect, causing the random alphanumeric representations to be displayed to the entity includes causing the random number, which includes the random digits in the designated order, to be displayed to the entity. In further accordance with this aspect, determining whether the speech includes the reading of each random alphanumeric representation includes determining whether the speech includes a recitation of the random digits in the designated order. Accordingly, authenticating the user at step 514 may be based at least in part on the speech including the recitation of the random digits in the designated order. Not authenticating the user at step 516 may be based at least in part on the speech not including the recitation of the random digits in the designated order.

In a first implementation of this aspect, the recitation of the random digits in the speech includes a recitation of the random digits as independent (e.g., separate, individual, or distinct) numbers. For instance, the numbers “1 9 2 1 8 4” shown in FIG. 4 may be recited as “One, nine, two, one, eight, four.”

In a second implementation of this aspect, the recitation of the random digits in the speech includes a recitation of the random number as a whole, rather than a recitation of the random digits as independent numbers. For instance, the numbers “1 9 2 1 8 4” shown in FIG. 4 may be recited as “One-hundred and ninety-two thousand, one-hundred and eighty-four.”

In yet another example embodiment, the random representations are random pictures. In accordance with this embodiment, each random picture has a random entropy. In further accordance with this embodiment, causing the random representations to be displayed to the entity at step 506 includes causing the random pictures to be displayed to the entity. In further accordance with this embodiment, determining whether the speech includes the verbal identification of each random representation includes determining whether the speech includes a description of each random picture. Accordingly, authenticating the user at step 514 may be based at least in part on the speech including the description of each random picture. Not authenticating the user at step 516 may be based at least in part on the speech not including the description of each random picture. The description of each random picture may include a description of an object that is depicted in the random picture (e.g., a subject of the random picture).

In still another example embodiment, the random representations are random symbols. Each random symbol is neither a number nor a letter in an alphabet. In accordance with this embodiment, each random symbol has a random entropy. In further accordance with this embodiment, causing the random representations to be displayed to the entity at step 506 includes causing the random symbols to be displayed to the entity. In further accordance with this embodiment, determining whether the speech includes the verbal identification of each random representation includes determining whether the speech includes a description of each random symbol. Accordingly, authenticating the user at step 514 may be based at least in part on the speech including the description of each random symbol. Not authenticating the user at step 516 may be based at least in part on the speech not including the description of each random symbol. The description of each random symbol may be limited to a threshold number of words (e.g., one word or two words), though the scope of the example embodiments is not limited in this respect.

In yet another example embodiment, receiving the credential from the entity at step 502 includes receiving the credential via a first website that is displayed to the entity. For instance, the first website may be displayed on a display of a machine that belongs to or is otherwise accessible to the entity. In accordance with this embodiment, causing the random representations to be displayed to the entity at step 506 includes redirecting the entity to a second website that presents the random representations to the entity. For instance, the second website may be displayed on the display of the machine.

In still another example embodiment, causing the random representations to be displayed to the entity includes causing the random representations to be displayed to the entity at a time instance. In accordance with this embodiment, analyzing the representation of the speech of the entity at step 508 further includes determining whether the representation of the speech of the entity is received within a specified period of time that begins at the time instance. In further accordance with this embodiment, if the representation of the speech of the entity is received within the specified period of time that begins at the time instance, flow continues to step 514. Otherwise, flow continues to step 516. Accordingly, authenticating the user at step 514 may be based at least in part on the representation of the speech of the entity being received within the specified period of time. Not authenticating the user at step 516 may be based at least in part on the representation of the speech of the entity not being received within the specified period of time.

In some example embodiments, one or more steps 502, 504, 506, 508, 510, 512, 514, and/or 516 of flowchart 500 may not be performed. Moreover, steps in addition to or in lieu of steps 502, 504, 506, 508, 510, 512, 514, and/or 516 may be performed. For instance, in an example embodiment, the method of flowchart 500 further includes utilizing the representation of the speech of the entity in a training set for a machine learning-based voice recognition model. In an example implementation, the model training logic 816 utilizes the speech representation 828, which includes the representation of the speech of the entity, in the training set for the machine learning-based voice recognition model.

In another example embodiment, determining whether the voice that is characterized by the speech corresponds to the voice profile that characterizes the voice of the user at step 510 includes determining whether a cadence of the speech of the entity corresponds to a reference cadence that is associated with the user. It will be recognized that the cadence of the speech is represented by the representation of the speech. It will be further recognized that the voice profile may include a representation of the reference cadence. Accordingly, authenticating the user at step 514 may be based at least in part on the cadence of the speech of the entity corresponding to the reference cadence. Not authenticating the user at step 516 may be based at least in part on the cadence of the speech of the entity not corresponding to the reference cadence.

In an aspect of this embodiment, the method of flowchart 500 further includes storing a representation of the reference cadence in a secure enclave (e.g., a trusted platform module (TPM)) of a machine that is associated with the user, in a secure enclave of a browser that is configured to execute on the machine, or in a secure enclave of a server that is located remotely from the machine. For instance, the machine may belong to the user or be assigned to the user in an enterprise. In an example implementation, the voice profile logic 824 stores the reference cadence in such a secure enclave. For example, the reference cadence may be included in the voice profile 834, which is stored in the store 810. In accordance with this example, the store 810 may include the secure enclave. For instance, the store 810 may be the secure enclave.

In yet another example embodiment, the method of flowchart 500 further includes storing the voice profile that characterizes the voice of the user in a secure enclave (e.g., a trusted platform module (TPM)) on a machine that is associated with the user, in a secure enclave within a browser that is configured to execute on the machine, or in a secure enclave on a server that is located remotely from the machine. In an example implementation, the voice profile logic 824 stores the voice profile 834 in such a secure enclave. For example, the store 810 may include (e.g., be) the secure enclave.

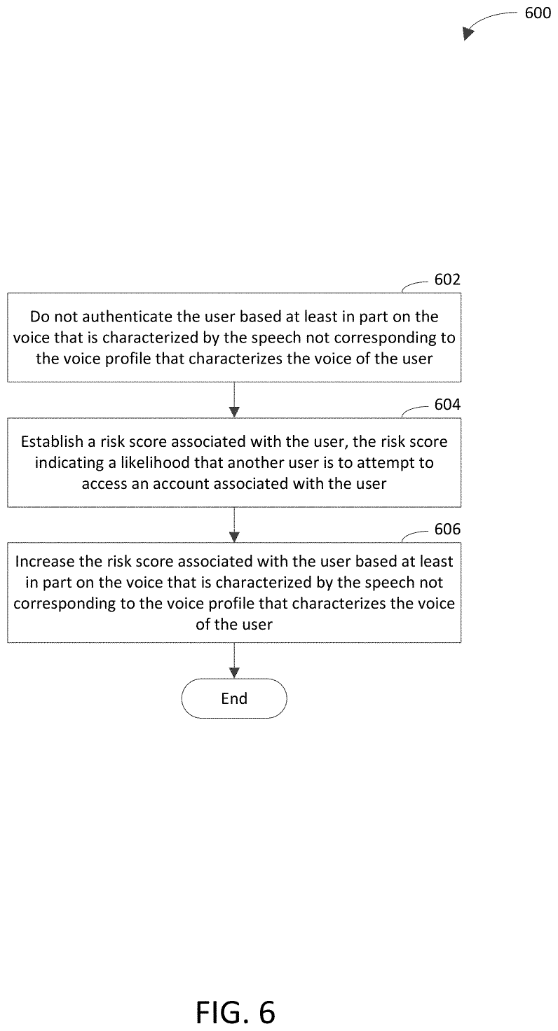

In still another example embodiment, step 516 is replaced by the steps shown in flowchart 600 of FIG. 6. As shown in FIG. 6, the method of flowchart 600 begins at step 602. In step 602, the user is not authenticated based at least in part on (e.g., as a result of) the voice that is characterized by the speech not corresponding to the voice profile that characterizes the voice of the user. In an example implementation, authentication logic 820 does not authenticate the user.

At step 604, a risk score associated with the user is established. The risk score indicates a likelihood that another user (e.g., a malicious entity) is to attempt to access an account associated with the user. For instance, the risk score may be established prior to the user not being authenticated at step 602. In an example implementation, the risk score logic 822 establishes a risk score 838 associated with the user to indicate the likelihood that another user is to attempt to access an account associated with the user.

At step 606, the risk score associated with the user is increased based at least in part on the voice that is characterized by the speech not corresponding to the voice profile that characterizes the voice of the user. In an example implementation, the risk score logic 822 increases the risk score 838 based at least in part on the voice that is characterized by the speech not corresponding to the voice profile 834, which characterizes the voice of the user. The analysis logic 818 may generate a voice comparison indicator 848 to indicate whether the voice that is characterized by the speech corresponds to the voice profile 834. The risk score logic 822 may increase the risk score 838 based on the voice comparison indicator 848 indicating that the voice that is characterized by the speech does not correspond to the voice profile 834.

In an aspect of this embodiment, the method of flowchart 600 further includes determining that the voice that is characterized by the speech corresponds to a second voice profile that characterizes a voice of a second user who is different from the user (e.g., rather than the voice profile that characterizes the voice of the user). In an example implementation, the analysis logic 818 determines that the voice that is characterized by the speech corresponds to the second voice profile. The analysis logic 818 may generate the voice comparison indicator 848 to further indicate that the voice that is characterized by the speech corresponds to the second voice profile. In accordance with this aspect, increasing the risk score associated with the user is based at least in part on the voice that is characterized by the speech corresponding to the second voice profile. For instance, the risk score logic 822 may increase the risk score 838 based at least in part on the voice comparison indicator 848 indicating that the voice that is characterized by the speech corresponds to the second voice profile.

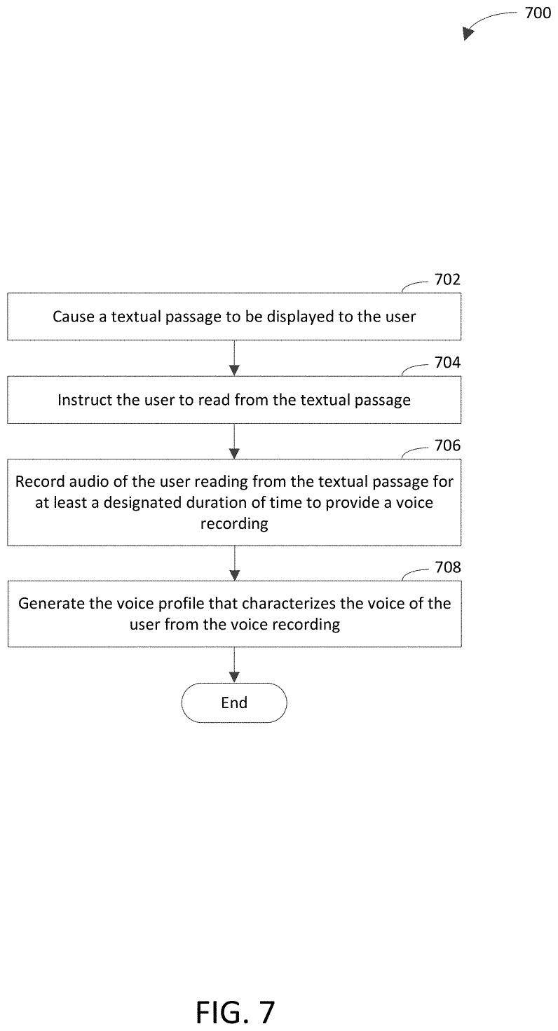

In yet another example embodiment, the method of flowchart 500 includes one or more of the steps shown in flowchart 700 of FIG. 7. As shown in FIG. 7, the method of flowchart 700 begins at step 702. In step 702, a textual passage is caused to be displayed to the user. In an example implementation, the display logic 814 causes a textual passage 844 to be displayed to the user.

At step 704, the user is instructed to read from the textual passage. In an example implementation, the display logic 814 instructs the user to read from the textual passage. For instance, the display logic 814 may display the read instruction 846 to instruct the user to read the textual passage 844 aloud.

At step 706, audio of the user reading from the textual passage is recorded for at least a designated duration of time to provide a voice recording. In an example implementation, the analysis logic 818 records the audio of the user reading from the textual passage 844 for at least the designated duration of time to provide an audio recording 840. The analysis logic 818 may store the audio recording 840 in the store 810.

At step 708, the voice profile that characterizes the voice of the user is generated from the voice recording. In an example implementation, the voice profile logic 824 generates the voice profile 834, which characterizes the voice of the user, from the audio recording 840.

It will be recognized that the computing system 800 may not include one or more of the randomization-based authentication logic 808, the store 810, the comparison logic 812, the display logic 814, the model training logic 816, the analysis logic 818, the authentication logic 820, the risk score logic 822, and/or the voice profile logic 824. Furthermore, the computing system 800 may include components in addition to or in lieu of the randomization-based authentication logic 808, the store 810, the comparison logic 812, the display logic 814, the model training logic 816, the analysis logic 818, the authentication logic 820, the risk score logic 822, and/or the voice profile logic 824.

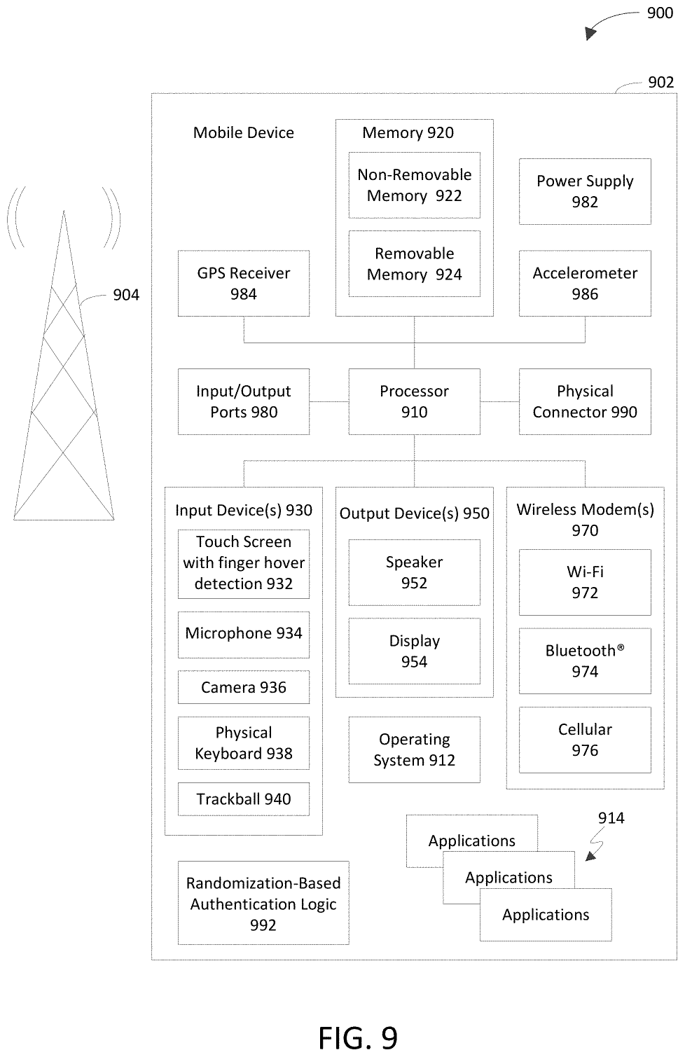

FIG. 9 is a system diagram of an exemplary mobile device 900 including a variety of optional hardware and software components, shown generally as 902. Any components 902 in the mobile device may communicate with any other component, though not all connections are shown, for ease of illustration. The mobile device 900 may be any of a variety of computing devices (e.g., cell phone, smartphone, handheld computer, Personal Digital Assistant (PDA), etc.) and may allow wireless two-way communications with one or more mobile communications networks 904, such as a cellular or satellite network, or with a local area or wide area network.

The mobile device 900 may include a processor 910 (e.g., signal processor, microprocessor, ASIC, or other control and processing logic circuitry) for performing such tasks as signal coding, data processing, input/output processing, power control, and/or other functions. An operating system 912 may control the allocation and usage of the components 902 and support for one or more applications 914 (a.k.a. application programs). The applications 914 may include common mobile computing applications (e.g., email applications, calendars, contact managers, web browsers, messaging applications) and any other computing applications (e.g., word processing applications, mapping applications, media player applications).

The mobile device 900 may include memory 920. The memory 920 may include non-removable memory 922 and/or removable memory 924. The non-removable memory 922 may include RAM, ROM, flash memory, a hard disk, or other well-known memory storage technologies. The removable memory 924 may include flash memory or a Subscriber Identity Module (SIM) card, which is well known in GSM communication systems, or other well-known memory storage technologies, such as “smart cards.” The memory 920 may store data and/or code for running the operating system 912 and the applications 914. Example data may include web pages, text, images, sound files, video data, or other data sets to be sent to and/or received from one or more network servers or other devices via one or more wired or wireless networks. Memory 920 may store a subscriber identifier, such as an International Mobile Subscriber Identity (IMSI), and an equipment identifier, such as an International Mobile Equipment Identifier (IMEI). Such identifiers may be transmitted to a network server to identify users and equipment.

The mobile device 900 may support one or more input devices 930, such as a touch screen 932, microphone 934, camera 936, physical keyboard 938 and/or trackball 940 and one or more output devices 950, such as a speaker 952 and a display 954. Touch screens, such as the touch screen 932, may detect input in different ways. For example, capacitive touch screens detect touch input when an object (e.g., a fingertip) distorts or interrupts an electrical current running across the surface. As another example, touch screens may use optical sensors to detect touch input when beams from the optical sensors are interrupted. Physical contact with the surface of the screen is not necessary for input to be detected by some touch screens. For example, the touch screen 932 may support a finger hover detection using capacitive sensing, as is well understood in the art. Other detection techniques may be used, including but not limited to camera-based detection and ultrasonic-based detection. To implement a finger hover, a user's finger is typically within a predetermined spaced distance above the touch screen, such as between 0.1 to 0.25 inches, or between 0.25 inches and 0.5 inches, or between 0.5 inches and 0.75 inches, or between 0.75 inches and 1 inch, or between 1 inch and 1.5 inches, etc.

The mobile device 900 may include randomization-based authentication logic 992. The randomization-based authentication logic 992 is configured to selectively authenticate a user using voice recognition and random representations in accordance with any one or more of the techniques described herein.

Other possible output devices (not shown) may include piezoelectric or other haptic output devices. Some devices may serve more than one input/output function. For example, touch screen 932 and display 954 may be combined in a single input/output device. The input devices 930 may include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 912 or applications 914 may include speech-recognition software as part of a voice control interface that allows a user to operate the mobile device 900 via voice commands. Furthermore, the mobile device 900 may include input devices and software that allows for user interaction via a user's spatial gestures, such as detecting and interpreting gestures to provide input to a gaming application.

Wireless modem(s) 970 may be coupled to antenna(s) (not shown) and may support two-way communications between the processor 910 and external devices, as is well understood in the art. The modem(s) 970 are shown generically and may include a cellular modem 976 for communicating with the mobile communication network 904 and/or other radio-based modems (e.g., Bluetooth® 974 and/or Wi-Fi 972). At least one of the wireless modem(s) 970 is typically configured for communication with one or more cellular networks, such as a GSM network for data and voice communications within a single cellular network, between cellular networks, or between the mobile device and a public switched telephone network (PSTN).

The mobile device may further include at least one input/output port 980, a power supply 982, a satellite navigation system receiver 984, such as a Global Positioning System (GPS) receiver, an accelerometer 986, and/or a physical connector 990, which may be a USB port, IEEE 1394 (FireWire) port, and/or RS-232 port. The illustrated components 902 are not required or all-inclusive, as any components may be deleted and other components may be added as would be recognized by one skilled in the art.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods may be used in conjunction with other methods.

Any one or more of the randomization-based authentication logic 108, the randomization-based authentication logic 808, the comparison logic 812, the display logic 814, the model training logic 816, the analysis logic 818, the authentication logic 820, the risk score logic 822, the voice profile logic 824, the randomization-based authentication logic 992, flowchart 500, flowchart 600, and/or flowchart 700 may be implemented in hardware, software, firmware, or any combination thereof.

For example, any one or more of the randomization-based authentication logic 108, the randomization-based authentication logic 808, the comparison logic 812, the display logic 814, the model training logic 816, the analysis logic 818, the authentication logic 820, the risk score logic 822, the voice profile logic 824, the randomization-based authentication logic 992, flowchart 500, flowchart 600, and/or flowchart 700 may be implemented, at least in part, as computer program code configured to be executed in one or more processors.

In another example, any one or more of the randomization-based authentication logic 108, the randomization-based authentication logic 808, the comparison logic 812, the display logic 814, the model training logic 816, the analysis logic 818, the authentication logic 820, the risk score logic 822, the voice profile logic 824, the randomization-based authentication logic 992, flowchart 500, flowchart 600, and/or flowchart 700 may be implemented, at least in part, as hardware logic/electrical circuitry. Such hardware logic/electrical circuitry may include one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. For instance, a SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### III. Further Discussion of Some Example Embodiments

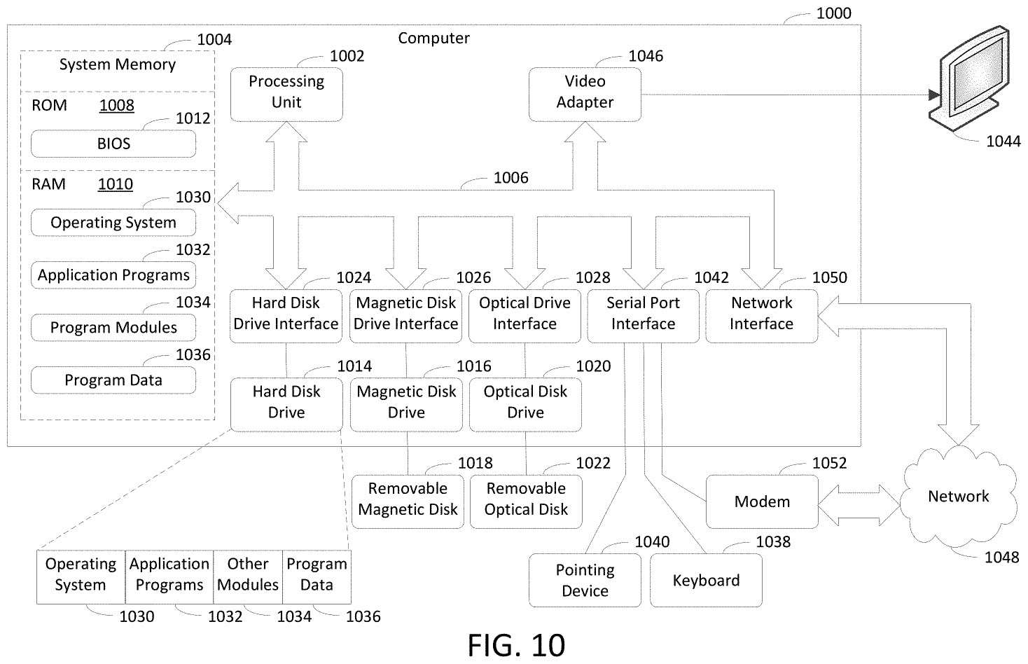

(A1) An example system (FIG. 1, 102A-102M or 106A-106N; FIG. 8, 800; FIG. 9, 900; FIG. 10, 1000) to selectively authenticate a user using voice recognition and random representations (842) comprises a memory (FIG. 9, 920; FIG. 10, 1004, 1008, 1010) and one or more processors (FIG. 9, 910; FIG. 10, 1002) coupled to the memory. The one or more processors are configured to compare (504) a credential (826) that is received from an entity to a reference credential (836) that is associated with the user to determine whether the credential corresponds to the reference credential. The one or more processors are further configured to cause (506) the random representations to be displayed to the entity based at least in part on the credential corresponding to the reference credential. Each random representation has a random entropy. The one or more processors are further configured to analyze (508) a representation (828) of speech of the entity to determine whether a voice that is characterized by the speech corresponds to a voice profile (834) that characterizes a voice of the user and to determine whether the speech includes a verbal identification of each random representation. The one or more processors are further configured to selectively authenticate (514, 516) the user based at least in part on whether the voice that is characterized by the speech corresponds to the voice profile that characterizes the voice of the user and further based at least in part on whether the speech includes the verbal identification of each random representation.

(A2) In the example system of A1, wherein the one or more processors are configured to: cause random alphanumeric representations to be displayed to the entity based at least in part on the credential corresponding to the reference credential, each random alphanumeric representation having a random entropy, each random alphanumeric representation including one or more alphanumeric characters; analyze the representation of the speech of the entity to determine whether the voice that is characterized by the speech corresponds to the voice profile that characterizes the voice of the user and to determine whether the speech includes a reading of each random alphanumeric representation; and selectively authenticate the user based at least in part on whether the voice that is characterized by the speech corresponds to the voice profile that characterizes the voice of the user and further based at least in part on whether the speech includes the reading of each random alphanumeric representation.

(A3) In the example system of any of A1-A2, wherein the one or more processors are configured to: cause random words to be displayed to the entity based at least in part on the credential corresponding to the reference credential, each random word having a random entropy; analyze the representation of the speech of the entity to determine whether the voice that is characterized by the speech corresponds to the voice profile that characterizes the voice of the user and to determine whether the speech includes a reading of each random word; and selectively authenticate the user based at least in part on whether the voice that is characterized by the speech corresponds to the voice profile that characterizes the voice of the user and further based at least in part on whether the speech includes the reading of each random word.

(A4) In the example system of any of A1-A3, wherein the one or more processors are configured to: cause a random number, which includes a plurality of random digits in a designated order, to be displayed to the entity based at least in part on the credential corresponding to the reference credential, each random digit of the plurality of random digits having a random entropy; analyze the representation of the speech of the entity to determine whether the voice that is characterized by the speech corresponds to the voice profile that characterizes the voice of the user and to determine whether the speech includes a recitation of the random digits in the designated order; and selectively authenticate the user based at least in part on whether the voice that is characterized by the speech corresponds to the voice profile that characterizes the voice of the user and further based at least in part on whether the speech includes the recitation of the random digits in the designated order.

(A5) In the example system of any of A1-A4, wherein the recitation of the random digits in the speech includes a recitation of the random number as a whole, rather than a recitation of the random digits as independent numbers.

(A6) In the example system of any of A1-A5, wherein the one or more processors are configured to: cause random pictures to be displayed to the entity based at least in part on the credential corresponding to the reference credential, each random picture having a random entropy; analyze the representation of the speech of the entity to determine whether the voice that is characterized by the speech corresponds to the voice profile that characterizes the voice of the user and to determine whether the speech includes a description of each random picture; and selectively authenticate the user based at least in part on whether the voice that is characterized by the speech corresponds to the voice profile that characterizes the voice of the user and further based at least in part on whether the speech includes the description of each random picture.

(A7) In the example system of any of A1-A6, wherein the one or more processors are configured to: cause random symbols to be displayed to the entity based at least in part on the credential corresponding to the reference credential, each random symbol having a random entropy, each random symbol not being a number and not being a letter in an alphabet; analyze the representation of the speech of the entity to determine whether the voice that is characterized by the speech corresponds to the voice profile that characterizes the voice of the user and to determine whether the speech includes a description of each random symbol; and selectively authenticate the user based at least in part on whether the voice that is characterized by the speech corresponds to the voice profile that characterizes the voice of the user and further based at least in part on whether the speech includes the description of each random symbol.

(A8) In the example system of any of A1-A7, wherein the random representations comprise at least five random representations.

(A9) In the example system of any of A1-A8, wherein the one or more processors are configured to: receive the credential via a first website that is displayed to the entity; and redirect the entity to a second website that presents the random representations to the entity.

(A10) In the example system of any of A1-A9, wherein the one or more processors are configured to: cause the random representations to be displayed to the entity via an encrypted hypertext transfer protocol secure (HTTPS) browser communication.

(A11) In the example system of any of A1-A10, wherein the one or more processors are configured to: analyze an encrypted hypertext transfer protocol secure (HTTPS) browser communication, which represents the speech of the entity, to determine whether the voice that is characterized by the speech corresponds to the voice profile that characterizes the voice of the user and to determine whether the speech includes the verbal identification of each random representation.

(A12) In the example system of any of A1-A11, wherein the one or more processors are configured to: cause the random representations to be displayed to the entity at a time instance; and selectively authenticate the user further based at least in part on whether the representation of the speech of the entity is received within a specified period of time that begins at the time instance.

(A13) In the example system of any of A1-A12, wherein the one or more processors are further configured to: utilize the representation of the speech of the entity in a training set for a machine learning-based voice recognition model.

(A14) In the example system of any of A1-A13, wherein the one or more processors are configured to: analyze the representation of the speech of the entity to determine whether a cadence of the speech of the entity corresponds to a reference cadence that is associated with the user; and selectively authenticate the user further based at least in part on whether the cadence of the speech of the entity corresponds to the reference cadence that is associated with the user.

(A15) In the example system of any of A1-A14, wherein the one or more processors are further configured to: store a representation of the reference cadence in a secure enclave of a machine that is associated with the user or in a secure enclave of a browser that is configured to execute on the machine.

(A16) In the example system of any of A1-A15, wherein the one or more processors are further configured to: store the voice profile that characterizes the voice of the user in a secure enclave of a machine that is associated with the user or in a secure enclave of a browser that is configured to execute on the machine.

(A17) In the example system of any of A1-A16, wherein the one or more processors are further configured to: store the voice profile that characterizes the voice of the user in a secure enclave of a server.

(A18) In the example system of any of A1-A17, wherein the one or more processors are configured to: not authenticate the user based at least in part on the voice that is characterized by the speech not corresponding to the voice profile that characterizes the voice of the user; establish a risk score associated with the user, the risk score indicating a likelihood that another user is to attempt to access an account associated with the user; and increase the risk score associated with the user based at least in part on the voice that is characterized by the speech not corresponding to the voice profile that characterizes the voice of the user.

(A19) In the example system of any of A1-A18, wherein the one or more processors are configured to: determine that the voice that is characterized by the speech corresponds to a second voice profile that characterizes a voice of a second user who is different from the user; and increase the risk score associated with the user based at least in part on the voice that is characterized by the speech corresponding to the second voice profile that characterizes the voice of the second user.

(A20) In the example system of any of A1-A19, wherein the one or more processors are further configured to: cause a textual passage to be displayed to the user; instruct the user to read from the textual passage; record audio of the user reading from the textual passage for at least a designated duration of time to provide a voice recording; and generate the voice profile that characterizes the voice of the user from the voice recording.

(B1) An example method of selectively authenticating a user using voice recognition and random representations (842), the method implemented by a computing system (FIG. 1, 102A-102M or 106A-106N; FIG. 8, 800; FIG. 9, 900; FIG. 10, 1000), comprises receiving (502) a credential (826) from an entity. The method further comprises comparing (504) the credential to a reference credential (836) that is associated with the user to determine whether the credential corresponds to the reference credential. The method further comprises causing (506) the random representations to be displayed to the entity based at least in part on the credential corresponding to the reference credential. Each random representation has a random entropy. The method further comprises analyzing (508) a representation (828) of speech of the entity to determine whether a voice that is characterized by the speech corresponds to a voice profile (834) that characterizes a voice of the user and to determine whether the speech includes a verbal identification of each random representation. The method further comprises selectively authenticating (514, 516) the user based at least in part on whether the voice that is characterized by the speech corresponds to the voice profile that characterizes the voice of the user and further based at least in part on whether the speech includes the verbal identification of each random representation.

(B2) In the method of B1, wherein causing the random representations to be displayed comprises: causing random alphanumeric representations to be displayed to the entity based at least in part on the credential corresponding to the reference credential, each random alphanumeric representation having a random entropy. Each random alphanumeric representation includes one or more alphanumeric characters. Analyzing the representation of the speech of the entity comprises: analyzing the representation of the speech of the entity to determine whether the voice that is characterized by the speech corresponds to the voice profile that characterizes the voice of the user and to determine whether the speech includes a reading of each random alphanumeric representation. Selectively authenticating the user comprises: selectively authenticating the user based at least in part on whether the voice that is characterized by the speech corresponds to the voice profile that characterizes the voice of the user and further based at least in part on whether the speech includes the reading of each random alphanumeric representation.

(B3) In the method of any of B1-B2, wherein causing the random alphanumeric representations to be displayed comprises: causing random words to be displayed to the entity based at least in part on the credential corresponding to the reference credential, each random word having a random entropy. Analyzing the representation of the speech of the entity comprises: analyzing the representation of the speech of the entity to determine whether the voice that is characterized by the speech corresponds to the voice profile that characterizes the voice of the user and to determine whether the speech includes a reading of each random word. Selectively authenticating the user comprises: selectively authenticating the user based at least in part on whether the voice that is characterized by the speech corresponds to the voice profile that characterizes the voice of the user and further based at least in part on whether the speech includes the reading of each random word.

(B4) In the method of any of B1-B3, wherein causing the random alphanumeric representations to be displayed comprises: causing a random number, which includes a plurality of random digits in a designated order, to be displayed to the entity based at least in part on the credential corresponding to the reference credential. Each random digit of the plurality of random digits has a random entropy. Analyzing the representation of the speech of the entity comprises: analyzing the representation of the speech of the entity to determine whether the voice that is characterized by the speech corresponds to the voice profile that characterizes the voice of the user and to determine whether the speech includes a recitation of the random digits in the designated order. Selectively authenticating the user comprises: selectively authenticating the user based at least in part on whether the voice that is characterized by the speech corresponds to the voice profile that characterizes the voice of the user and further based at least in part on whether the speech includes the recitation of the random digits in the designated order.

(B5) In the method of any of B1-B4, wherein the recitation of the random digits in the speech includes a recitation of the random number as a whole, rather than a recitation of the random digits as independent numbers.

(B6) In the method of any of B1-B5, wherein causing the random representations to be displayed comprises: causing random pictures to be displayed to the entity based at least in part on the credential corresponding to the reference credential. Each random picture has a random entropy. Analyzing the representation of the speech of the entity comprises: analyzing the representation of the speech of the entity to determine whether the voice that is characterized by the speech corresponds to the voice profile that characterizes the voice of the user and to determine whether the speech includes a description of each random picture. Selectively authenticating the user comprises: selectively authenticating the user based at least in part on whether the voice that is characterized by the speech corresponds to the voice profile that characterizes the voice of the user and further based at least in part on whether the speech includes the description of each random picture.

(B7) In the method of any of B1-B6, wherein causing the random representations to be displayed comprises: causing random symbols to be displayed to the entity based at least in part on the credential corresponding to the reference credential, each random symbol having a random entropy. Each random symbol is not a number and is not a letter in an alphabet. Analyzing the representation of the speech of the entity comprises: analyzing the representation of the speech of the entity to determine whether the voice that is characterized by the speech corresponds to the voice profile that characterizes the voice of the user and to determine whether the speech includes a description of each random symbol. Selectively authenticating the user comprises: selectively authenticating the user based at least in part on whether the voice that is characterized by the speech corresponds to the voice profile that characterizes the voice of the user and further based at least in part on whether the speech includes the description of each random symbol.

(B8) In the method of any of B1-B7, wherein the random representations comprise at least five random representations.

(B9) In the method of any of B1-B8, wherein receiving the credential from the entity comprises receiving the credential via a first website that is displayed to the entity; and wherein causing the random representations to be displayed to the entity comprises redirecting the entity to a second website that presents the random representations to the entity.

(B10) In the method of any of B1-B9, wherein causing the random representations to be displayed to the entity comprises: causing the random representations to be displayed to the entity via an encrypted hypertext transfer protocol secure (HTTPS) browser communication.

(B11) In the method of any of B1-B10, wherein analyzing the representation of the speech of the entity comprises: analyzing an encrypted hypertext transfer protocol secure (HTTPS) browser communication, which represents the speech of the entity, to determine whether the voice that is characterized by the speech corresponds to the voice profile that characterizes the voice of the user and to determine whether the speech includes the verbal identification of each random representation.

(B12) In the method of any of B1-B11, wherein causing the random representations to be displayed comprises causing the random representations to be displayed to the entity at a time instance; and wherein selectively authenticating the user comprises selectively authenticating the user further based at least in part on whether the representation of the speech of the entity is received within a specified period of time that begins at the time instance.

(B13) In the method of any of B1-B12, further comprising: utilizing the representation of the speech of the entity in a training set for a machine learning-based voice recognition model.

(B14) In the method of any of B1-B13, wherein analyzing the representation of the speech of the entity comprises analyzing the representation of the speech of the entity to determine whether a cadence of the speech of the entity corresponds to a reference cadence that is associated with the user; and wherein selectively authenticating the user comprises selectively authenticating the user further based at least in part on whether the cadence of the speech of the entity corresponds to the reference cadence that is associated with the user.

(B15) In the method of any of B1-B14, further comprising: storing a representation of the reference cadence in a secure enclave of a machine that is associated with the user or in a secure enclave of a browser that is configured to execute on the machine.

(B16) In the method of any of B1-B15, further comprising: storing the voice profile that characterizes the voice of the user in a secure enclave of a machine that is associated with the user or in a secure enclave of a browser that is configured to execute on the machine.

(B17) In the method of any of B1-B16, further comprising: storing the voice profile that characterizes the voice of the user in a secure enclave of a server.

(B18) In the method of any of B1-B17, wherein selectively authenticating the user comprises: not authenticating the user based at least in part on the voice that is characterized by the speech not corresponding to the voice profile that characterizes the voice of the user. The method further comprises: establishing a risk score associated with the user, the risk score indicating a likelihood that another user is to attempt to access an account associated with the user; and increasing the risk score associated with the user based at least in part on the voice that is characterized by the speech not corresponding to the voice profile that characterizes the voice of the user.

(B19) In the method of any of B1-B18, further comprising: determining that the voice that is characterized by the speech corresponds to a second voice profile that characterizes a voice of a second user who is different from the user. Increasing the risk score associated with the user comprises: increasing the risk score associated with the user based at least in part on the voice that is characterized by the speech corresponding to the second voice profile that characterizes the voice of the second user.

(B20) In the method of any of B1-B19, further comprising: causing a textual passage to be displayed to the user; instructing the user to read from the textual passage; recording audio of the user reading from the textual passage for at least a designated duration of time to provide a voice recording; and generating the voice profile that characterizes the voice of the user from the voice recording.

(C1) An example computer program product (FIG. 9, 924; FIG. 10, 1018, 1022) comprising a computer-readable storage medium having instructions recorded thereon for enabling a processor-based system (FIG. 1, 102A-102M or 106A-106N; FIG. 8, 800; FIG. 9, 900; FIG. 10, 1000) to selectively authenticate a user using voice recognition and random representations (842) by performing operations, the operations comprising: comparing (504) a credential (826) that is received from an entity to a reference credential (836) that is associated with the user to determine whether the credential corresponds to the reference credential; causing (506) the random representations to be displayed to the entity based at least in part on the credential corresponding to the reference credential, each random representation having a random entropy; analyzing (508) a representation (828) of speech of the entity to determine whether a voice that is characterized by the speech corresponds to a voice profile (834) that characterizes a voice of the user and to determine whether the speech includes a verbal identification of each random representation; and selectively authenticating (514, 516) the user based at least in part on whether the voice that is characterized by the speech corresponds to the voice profile that characterizes the voice of the user and further based at least in part on whether the speech includes the verbal identification of each random representation.

### IV. Example Computer System

FIG. 10 depicts an example computer 1000 in which embodiments may be implemented. Any one or more of the user devices 102A-102M and/or any one or more of the servers 106A-106N shown in FIG. 1 and/or computing system 800 shown in FIG. 8 may be implemented using computer 1000, including one or more features of computer 1000 and/or alternative features. Computer 1000 may be a general-purpose computing device in the form of a conventional personal computer, a mobile computer, or a workstation, for example, or computer 1000 may be a special purpose computing device. The description of computer 1000 provided herein is provided for purposes of illustration, and is not intended to be limiting. Embodiments may be implemented in further types of computer systems, as would be known to persons skilled in the relevant art(s).

As shown in FIG. 10, computer 1000 includes a processing unit 1002, a system memory 1004, and a bus 1006 that couples various system components including system memory 1004 to processing unit 1002. Bus 1006 represents one or more of any of several types of bus structures, including a memory bus or memory controller, a peripheral bus, an accelerated graphics port, and a processor or local bus using any of a variety of bus architectures. System memory 1004 includes read only memory (ROM) 1008 and random access memory (RAM) 1010. A basic input/output system 1012 (BIOS) is stored in ROM 1008.

Computer 1000 also has one or more of the following drives: a hard disk drive 1014 for reading from and writing to a hard disk, a magnetic disk drive 1016 for reading from or writing to a removable magnetic disk 1018, and an optical disk drive 1020 for reading from or writing to a removable optical disk 1022 such as a CD ROM, DVD ROM, or other optical media. Hard disk drive 1014, magnetic disk drive 1016, and optical disk drive 1020 are connected to bus 1006 by a hard disk drive interface 1024, a magnetic disk drive interface 1026, and an optical drive interface 1028, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1030, one or more application programs 1032, other program modules 1034, and program data 1036. Application programs 1032 or program modules 1034 may include, for example, computer program logic for implementing any one or more of (e.g., at least a portion of) the randomization-based authentication logic 108, the randomization-based authentication logic 808, the comparison logic 812, the display logic 814, the model training logic 816, the analysis logic 818, the authentication logic 820, the risk score logic 822, the voice profile logic 824, the randomization-based authentication logic 992, flowchart 500 (including any step of flowchart 500), flowchart 600 (including any step of flowchart 600), and/or flowchart 700 (including any step of flowchart 700), as described herein.

A user may enter commands and information into the computer 1000 through input devices such as keyboard 1038 and pointing device 1040. Other input devices (not shown) may include a microphone, joystick, game pad, satellite dish, scanner, touch screen, camera, accelerometer, gyroscope, or the like. These and other input devices are often connected to the processing unit 1002 through a serial port interface 1042 that is coupled to bus 1006, but may be connected by other interfaces, such as a parallel port, game port, or a universal serial bus (USB).

A display device 1044 (e.g., a monitor) is also connected to bus 1006 via an interface, such as a video adapter 1046. In addition to display device 1044, computer 1000 may include other peripheral output devices (not shown) such as speakers and printers.

Computer 1000 is connected to a network 1048 (e.g., the Internet) through a network interface or adapter 1050, a modem 1052, or other means for establishing communications over the network. Modem 1052, which may be internal or external, is connected to bus 1006 via serial port interface 1042.

As used herein, the terms “computer program medium” and “computer-readable storage medium” are used to generally refer to media (e.g., non-transitory media) such as the hard disk associated with hard disk drive 1014, removable magnetic disk 1018, removable optical disk 1022, as well as other media such as flash memory cards, digital video disks, random access memories (RAMs), read only memories (ROM), and the like. A computer-readable storage medium is not a signal, such as a carrier signal or a propagating signal. For instance, a computer-readable storage medium may not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 1032 and other program modules 1034) may be stored on the hard disk, magnetic disk, optical disk, ROM, or RAM. Such computer programs may also be received via network interface 1050 or serial port interface 1042. Such computer programs, when executed or loaded by an application, enable computer 1000 to implement features of embodiments discussed herein. Accordingly, such computer programs represent controllers of the computer 1000.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### V. Conclusion

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A system to selectively authenticate a user using voice recognition and random representations, the system comprising:
a memory; and
one or more processors coupled to the memory, the one or more processors configured to:
compare a credential that is received from an entity to a reference credential that is associated with the user to determine whether the credential corresponds to the reference credential;
cause the random representations to be displayed to the entity based at least in part on the credential corresponding to the reference credential, each random representation having a random entropy;
analyze a representation of speech of the entity to determine whether a voice that is characterized by the speech corresponds to a voice profile that characterizes a voice of the user and to determine whether the speech includes a verbal identification of each random representation; and
selectively authenticate the user based at least in part on whether the voice that is characterized by the speech corresponds to the voice profile that characterizes the voice of the user and further based at least in part on whether the speech includes the verbal identification of each random representation.

2. The system of claim 1, wherein the one or more processors are configured to:
cause random alphanumeric representations to be displayed to the entity based at least in part on the credential corresponding to the reference credential, each random alphanumeric representation having a random entropy, each random alphanumeric representation including one or more alphanumeric characters;
analyze the representation of the speech of the entity to determine whether the voice that is characterized by the speech corresponds to the voice profile that characterizes the voice of the user and to determine whether the speech includes a reading of each random alphanumeric representation; and
selectively authenticate the user based at least in part on whether the voice that is characterized by the speech corresponds to the voice profile that characterizes the voice of the user and further based at least in part on whether the speech includes the reading of each random alphanumeric representation.

3. The system of claim 2, wherein the one or more processors are configured to:
cause random words to be displayed to the entity based at least in part on the credential corresponding to the reference credential, each random word having a random entropy;
analyze the representation of the speech of the entity to determine whether the voice that is characterized by the speech corresponds to the voice profile that characterizes the voice of the user and to determine whether the speech includes a reading of each random word; and
selectively authenticate the user based at least in part on whether the voice that is characterized by the speech corresponds to the voice profile that characterizes the voice of the user and further based at least in part on whether the speech includes the reading of each random word.

4. The system of claim 2, wherein the one or more processors are configured to:
cause a random number, which includes a plurality of random digits in a designated order, to be displayed to the entity based at least in part on the credential corresponding to the reference credential, each random digit of the plurality of random digits having a random entropy;
analyze the representation of the speech of the entity to determine whether the voice that is characterized by the speech corresponds to the voice profile that characterizes the voice of the user and to determine whether the speech includes a recitation of the random digits in the designated order; and
selectively authenticate the user based at least in part on whether the voice that is characterized by the speech corresponds to the voice profile that characterizes the voice of the user and further based at least in part on whether the speech includes the recitation of the random digits in the designated order.

5. The system of claim 4, wherein the recitation of the random digits in the speech includes a recitation of the random number as a whole, rather than a recitation of the random digits as independent numbers.

6. The system of claim 1, wherein the one or more processors are configured to:
analyze an encrypted hypertext transfer protocol secure (HTTPS) browser communication, which represents the speech of the entity, to determine whether the voice that is characterized by the speech corresponds to the voice profile that characterizes the voice of the user and to determine whether the speech includes the verbal identification of each random representation.

7. The system of claim 1, wherein the one or more processors are configured to:
cause the random representations to be displayed to the entity at a time instance; and
selectively authenticate the user further based at least in part on whether the representation of the speech of the entity is received within a specified period of time that begins at the time instance.

8. The system of claim 1, wherein the one or more processors are configured to:
analyze the representation of the speech of the entity to determine whether a cadence of the speech of the entity corresponds to a reference cadence that is associated with the user; and
selectively authenticate the user further based at least in part on whether the cadence of the speech of the entity corresponds to the reference cadence that is associated with the user.

9. The system of claim 8, wherein the one or more processors are further configured to:
store a representation of the reference cadence in a secure enclave of a machine that is associated with the user or in a secure enclave of a browser that is configured to execute on the machine.

10. The system of claim 1, wherein the one or more processors are further configured to:
store the voice profile that characterizes the voice of the user in a secure enclave of a server.

11. The system of claim 1, wherein the one or more processors are configured to:
not authenticate the user based at least in part on the voice that is characterized by the speech not corresponding to the voice profile that characterizes the voice of the user;
establish a risk score associated with the user, the risk score indicating a likelihood that another user is to attempt to access an account associated with the user; and
increase the risk score associated with the user based at least in part on the voice that is characterized by the speech not corresponding to the voice profile that characterizes the voice of the user.

12. The system of claim 11, wherein the one or more processors are configured to:
determine that the voice that is characterized by the speech corresponds to a second voice profile that characterizes a voice of a second user who is different from the user; and
increase the risk score associated with the user based at least in part on the voice that is characterized by the speech corresponding to the second voice profile that characterizes the voice of the second user.

13. A method of selectively authenticating a user using voice recognition and random representations, the method implemented by a computing system, the method comprising:
receiving a credential from an entity;
comparing the credential to a reference credential that is associated with the user to determine whether the credential corresponds to the reference credential;
causing the random representations to be displayed to the entity based at least in part on the credential corresponding to the reference credential, each random representation having a random entropy;
analyzing a representation of speech of the entity to determine whether a voice that is characterized by the speech corresponds to a voice profile that characterizes a voice of the user and to determine whether the speech includes a verbal identification of each random representation; and
selectively authenticating the user based at least in part on whether the voice that is characterized by the speech corresponds to the voice profile that characterizes the voice of the user and further based at least in part on whether the speech includes the verbal identification of each random representation.

14. The method of claim 13, wherein causing the random representations to be displayed comprises:
causing random pictures to be displayed to the entity based at least in part on the credential corresponding to the reference credential, each random picture having a random entropy;
wherein analyzing the representation of the speech of the entity comprises:
analyzing the representation of the speech of the entity to determine whether the voice that is characterized by the speech corresponds to the voice profile that characterizes the voice of the user and to determine whether the speech includes a description of each random picture; and
wherein selectively authenticating the user comprises:
selectively authenticating the user based at least in part on whether the voice that is characterized by the speech corresponds to the voice profile that characterizes the voice of the user and further based at least in part on whether the speech includes the description of each random picture.

15. The method of claim 13, wherein causing the random representations to be displayed comprises:
causing random symbols to be displayed to the entity based at least in part on the credential corresponding to the reference credential, each random symbol having a random entropy, each random symbol not being a number and not being a letter in an alphabet;
wherein analyzing the representation of the speech of the entity comprises:
analyzing the representation of the speech of the entity to determine whether the voice that is characterized by the speech corresponds to the voice profile that characterizes the voice of the user and to determine whether the speech includes a description of each random symbol; and
wherein selectively authenticating the user comprises:
selectively authenticating the user based at least in part on whether the voice that is characterized by the speech corresponds to the voice profile that characterizes the voice of the user and further based at least in part on whether the speech includes the description of each random symbol.

16. The method of claim 13, wherein the random representations comprise at least five random representations.

17. The method of claim 13, wherein receiving the credential from the entity comprises:
receiving the credential via a first website that is displayed to the entity; and
wherein causing the random representations to be displayed to the entity comprises:
redirecting the entity to a second website that presents the random representations to the entity.

18. The method of claim 13, wherein causing the random representations to be displayed to the entity comprises:
causing the random representations to be displayed to the entity via an encrypted hypertext transfer protocol secure (HTTPS) browser communication.

19. The method of claim 13, further comprising:
utilizing the representation of the speech of the entity in a training set for a machine learning-based voice recognition model.

20. The method of claim 13, further comprising:
storing the voice profile that characterizes the voice of the user in a secure enclave of a machine that is associated with the user or in a secure enclave of a browser that is configured to execute on the machine.

21. The method of claim 13, further comprising:
causing a textual passage to be displayed to the user;
instructing the user to read from the textual passage;
recording audio of the user reading from the textual passage for at least a designated duration of time to provide a voice recording; and
generating the voice profile that characterizes the voice of the user from the voice recording.

22. A computer program product comprising a computer-readable storage medium having instructions recorded thereon for enabling a processor-based system to selectively authenticate a user using voice recognition and random representations by performing operations, the operations comprising:
comparing a credential that is received from an entity to a reference credential that is associated with the user to determine whether the credential corresponds to the reference credential;
causing the random representations to be displayed to the entity based at least in part on the credential corresponding to the reference credential, each random representation having a random entropy;
analyzing a representation of speech of the entity to determine whether a voice that is characterized by the speech corresponds to a voice profile that characterizes a voice of the user and to determine whether the speech includes a verbal identification of each random representation; and
selectively authenticating the user based at least in part on whether the voice that is characterized by the speech corresponds to the voice profile that characterizes the voice of the user and further based at least in part on whether the speech includes the verbal identification of each random representation.
